(19) United States
(12) Patent Application Publication
(10) Pub. No.: US 2017/0264601 A1
(43) Pub. Date: Sep. 14, 2017

(54) METHOD FOR AUTHENTICATING A USER, ASSOCIATE SYSTEM AND COMPUTER PROGRAM

(71) Applicants: INRIA INSTITUT NATIONAL DE RECHERCHE EN INFORMATIQUE ET EN AUTOMATIQUE, LE CHESNAY (FR); CHARITE UNIVERSITATSMEDIZIN BERLIN, BERLIN (DE)

(72) Inventors: FATMA IMAMOGLU, BERKELEY, CA (US); MAXIMILIAN GOLLA, HETTSTADT (DE); MARKUS DURMUTH, HAMBURG (DE); CLAUDE CASTELLUCCIA, MEYLAN (FR)

(73) Assignees: INRIA INSTITUT NATIONAL DE RECHERCHE EN INFORMATIQUE ET EN AUTOMATIQUE, LE CHESNAY (FR); CHARITE UNIVERSITATSMEDIZIN BERLIN, BERLIN (DE)

(21) Appl. No.: 15/319,676

(22) PCT Filed: Jun. 17, 2015
(86) PCT No.: PCT/EP2015/063629

§ 371 Date: Dec. 16, 2016

(30) Foreign Application Priority Data
Jun. 18, 2014 (EP) 14305941.8

(51) Int. Cl. H04L 29/06

(52) U.S. Cl. CPC H04L 63/08

(57) ABSTRACT

An authentication method wherein, in a training phase, a user is presented with a plurality of images called primed images and drawn randomly from a database (6) containing images. In an authentication phase, the user is presented with a plurality of degraded versions of at least a subset of the primed images and with a plurality of degraded versions of non-primed images extracted from the database. After receiving from the user respective identifications of the presented degraded primed images and non-primed images, a global score based is determined. The user is authenticated based upon the determined global score.

The present invention generally relates to security applications for authenticating users in communication services. In general, an authentication step is required when a user, e.g. through a telecommunication device, requests access to a protected resource.

Current forms of user authentication are generally based on passwords or some secret that the user has to remember. Depending on the system the authentication procedure can have different complexities. These so called knowledge-based authentication systems suffer from the competing requirements of security and usability, which are hard to fulfill.

In general, users have to manage a large number of accounts and have to pass an authentication procedure on these accounts each time they want to have access. However, most of the users are incapable or reluctant to memorize a large number of strong passwords. Hence, they use weak, easy to guess passwords, or even the very same password on all the accounts, an insecure practice which is widely discouraged.

Thus, according to a first aspect, the invention provides a method for authenticating a user, said method being characterized in comprising the followings steps implemented by a processor:
in a training phase, presenting a user with a plurality of images called primed images and drawn randomly from a database containing images
in an authentication phase, presenting said user with a plurality of degraded versions of at least a subset of said primed images and with a plurality of degraded versions of non primed images extracted from said memory;
receiving from said user respective identifications of said presented degraded primed images and presented non primed images;
determining a global score based upon said received identifications; and
authenticating said user based upon the determined global score.

The first aspect of the invention thus provides a method to authenticate a user by means of implicit memory that enables to increase the performance and security of the authentication compared to usual procedures that are generally based on passwords.

In embodiments, the method for authenticating a user according to the invention includes one or several of the following features:
degraded version of an image is the Mooney image of said image;
the method includes the steps of :
   determining, based upon at least identification received for a presented image, if said presented image has been correctly or incorrectly identified by the user; and
   assigning to a presented image of index i an image score equal to s(i), wherein the value of s(i) if the presented image is a correctly identified primed image is calculated as a function of pᵢ, and the value of s(i) if the presented image is an incorrectly identified non primed image is a function of nᵢ, wherein pᵢ is the probability for the image of index i to be correctly identified when primed, and nᵢ is the probability for the image of index i to be correctly identified when non primed; and
   calculating the global score as a function of the sum of the image score for the presented images;
the value of s(i) if the presented image is a correctly identified primed image is calculated as a function of log(pᵢ), and the value of s(i) if the presented image is an incorrectly identified non primed image is a function of log(1−nᵢ);
the value of s(i) if the presented image is an incorrectly identified primed image is calculated as a function of pᵢ, and the value of s(i) if the presented image is an correctly identified non primed image is a function of nᵢ;
the value of s(i) if the presented image is an incorrectly identified primed image is calculated as a function of log(1−pᵢ), and the value of s(i) if the presented image is a correctly identified non primed image is a function of log(nᵢ);
the determination of the correctness of the identification received for a presented image is further a function of the evaluation of the time needed by the user for providing the identification;
the images are presented if pᵢ−nᵢ>0.5.

According to a second aspect, the invention provides a computer program product comprising one or more stored sequences of instructions that are accessible to a processor and which, when executed by the processor, cause the processor to perform the steps of a method according to the first aspect of the invention.

According to a third aspect, the invention provides a system for authenticating a user, including a database containing images, said system being characterized in that said system is adapted for, in a training phase, presenting a user with a plurality of images called primed images and drawn randomly from the database, and is adapted for, in an authentication phase, presenting said user with a plurality of degraded versions of at least a subset of said primed images and with a plurality of degraded versions of non primed images extracted from said memory ;
the system being adapted for receiving from said user respective identifications of said presented degraded primed images and presented non primed images, for determining a global score based upon said received identifications; and for authenticating said user based upon the determined global score.

The present invention is illustrated by way of example, and not by way of limitation, in the figures of the accompanying drawings in which:

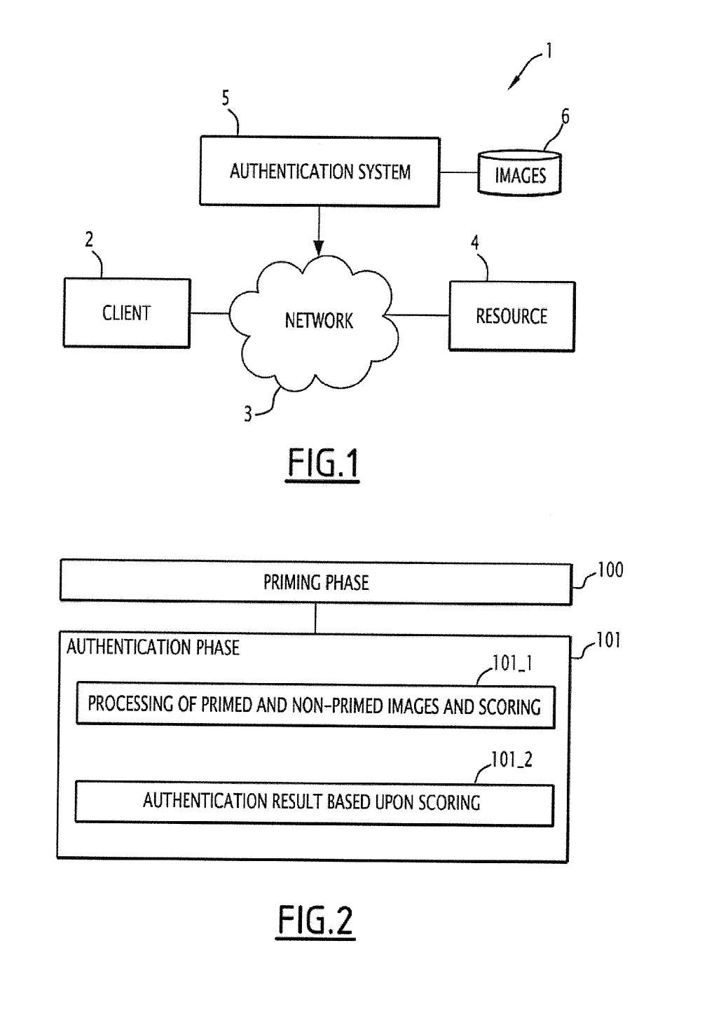

FIG. 1 shows a view of a network environment 1 in an embodiment of the invention;

FIG. 2 is a flow chart illustrating steps of a method according to an embodiment of the invention;

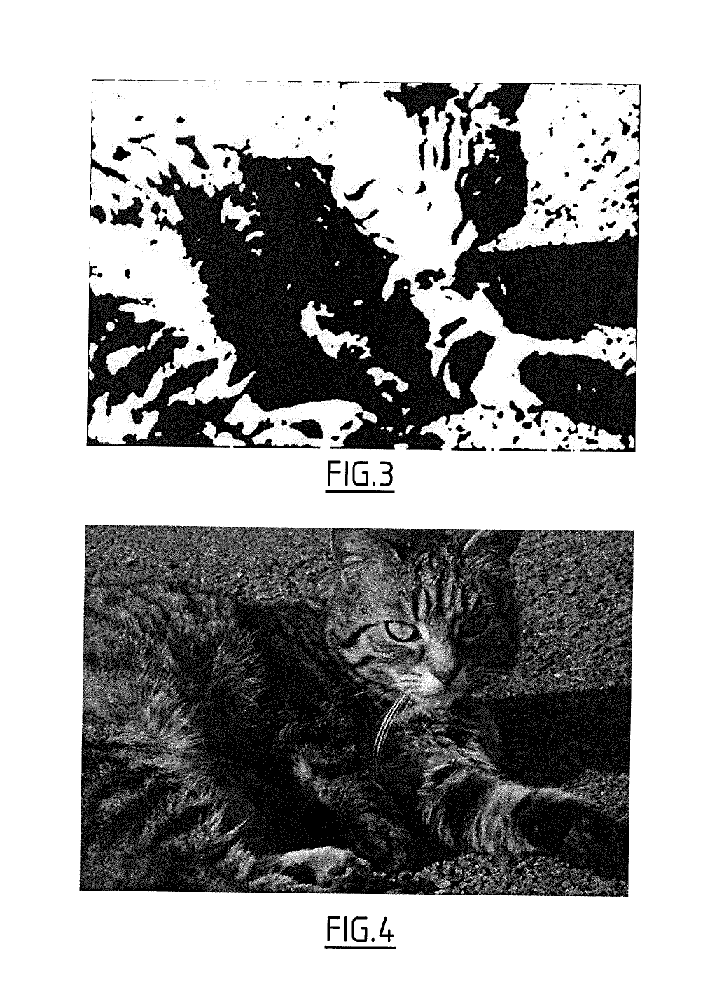

FIG. 3 is a view of a Mooney image;

FIG. 4 is a view of an image from which the Mooney image of FIG. 3 has been computed;

FIG. 5 is a view of a Mooney image;

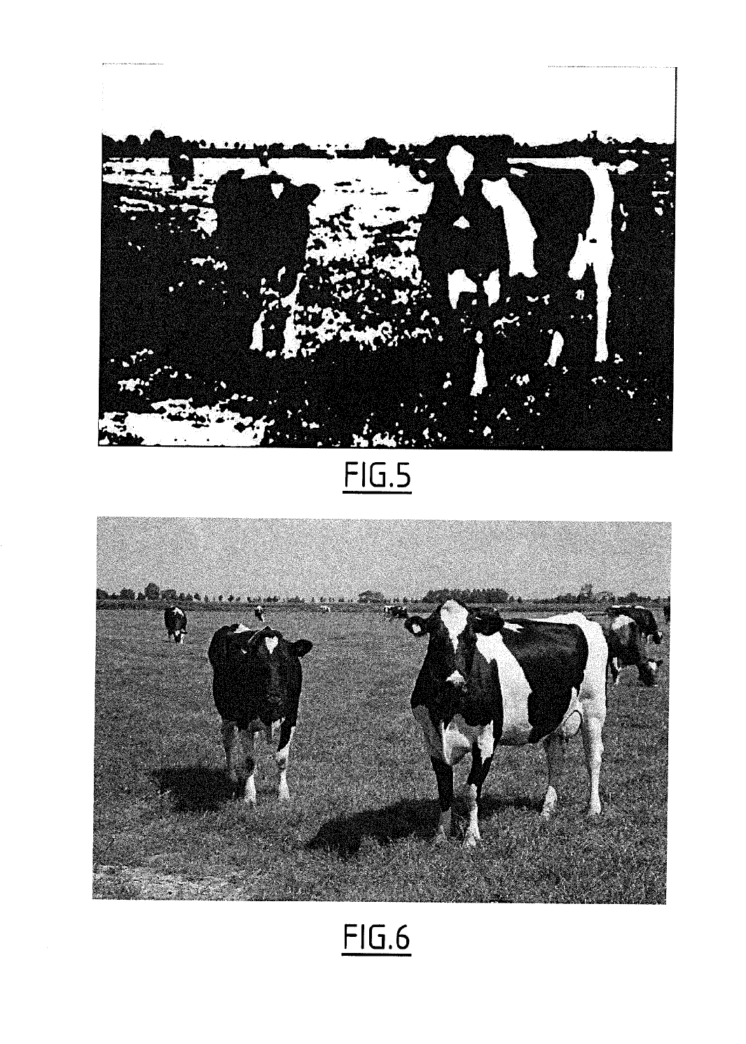

FIG. 6 is an image from which the Mooney image of FIG. 5 has been computed;

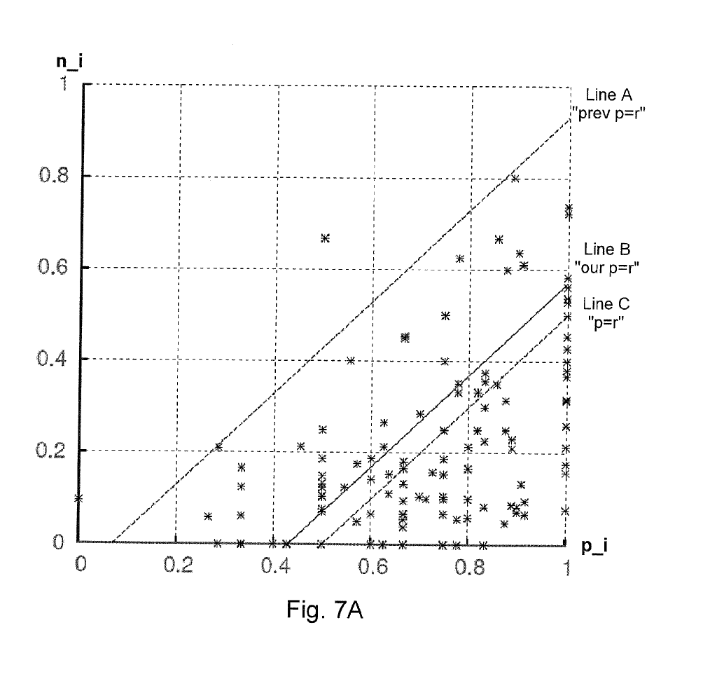

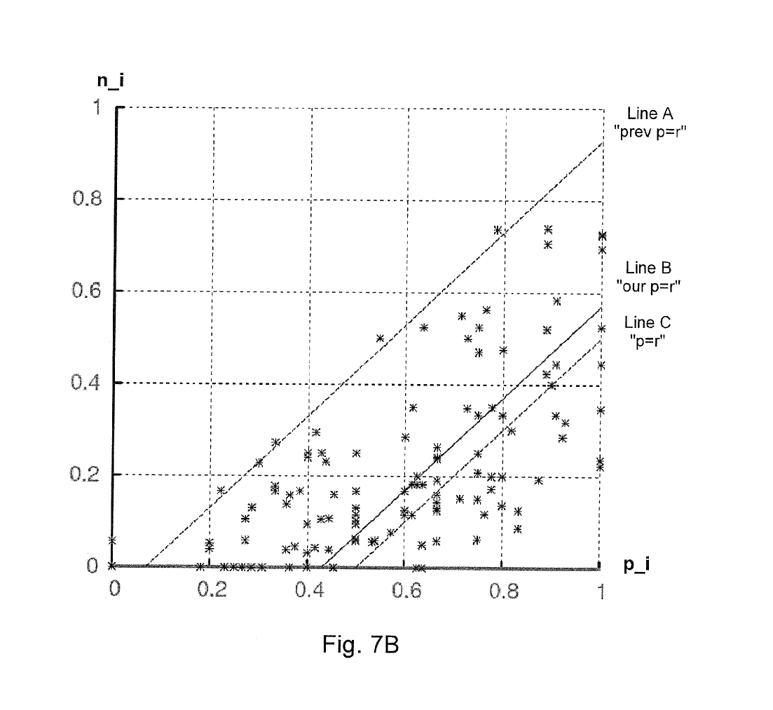

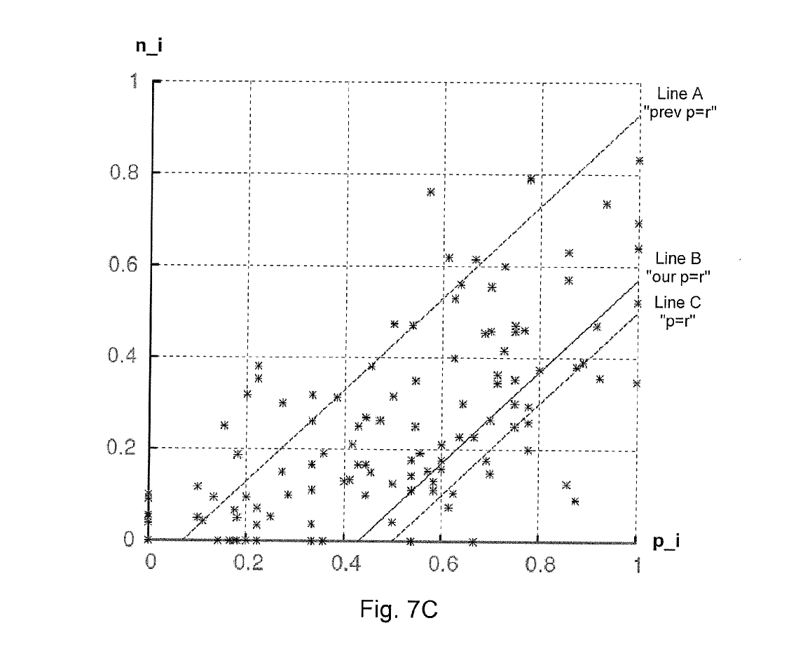

FIGS. 7A, 7B and 7C are plots illustrating experimental results in relation to the invention.

FIG. 1 shows a network environment 1 in an embodiment of the invention. The network environment 1 includes for example client terminals 2 (only one client terminal is shown on FIG. 1 for the sake of clarity of FIG. 1), an authentication system 5 associated to a database 6, a resource 4 and a telecommunication network 3 (for example the internet network) interconnecting client terminals 2, authentication system 5 and the resource 4.

Terminal client 2 includes for example personal computers, smart phones, etc.

The authentication system 5 includes for example a server.

The resource 4 is protected, meaning the access to the resource by a user through a terminal client 2 is provided only after the authentication system 5 has successfully authenticated a user having required access to the resource 4.

The image database 6 stores original images.

Said database 6 stores also associated to each original image, a degraded version of the original image.

The degradation applied is such that the content of the original image, for example an object, is hard to recognize by a user watching the corresponding degraded image when a user did not previously see the original image: in the degraded image, the object thus becomes a “hidden” object.

The database 6 stores a list of predefined labels. Each degraded image is associated to at least one predefined label. A predefined label identifies the “hidden” object in the degraded image and the same object in the associated original image.

A suitable degraded image is an image that is hard to recognize without a previous explicit presentation of the original image. However, if the original image is “primed”, i.e. previously shown to a user during the registration phase, recognizing the object from the degraded version becomes easy and the user will be able to correctly identify and label the “hidden” object. In some cases the hidden object in the degraded image can be recognizable by a non-primed user (i.e., a user who has not seen the original image before) as well. However, a primed user (i.e., a user who has seen the original image before) and a non-primed user may be distinguished by their recognition times (the time period necessary for a user to label the image during authentication). Indeed, when the original image was not presented in the priming session users' recognition times will be longer, i.e., users will be slower than when users were primed.

In the considered embodiment, the degraded versions of the original images are Mooney images.

A Mooney image is a thresholded, two-tone image that usually contains a single hidden object. This object is hard to recognize when a user did not previously see the original image. However, if the user has been previously primed, i.e., has been presented with the original image, or was given a hint what the hidden object could be, the users recognition is accelerated. Contrary, when the image is displayed long enough a user may recognize the hidden object without prior knowledge or exposure to the original image.

Mooney images are disclosed for example in Fatma Imamoglu, Thorsten Kahnt, Christof Koch, and John-Dylan Haynes, “Changes in functional connectivity support conscious object recognition”, NeuroImage, 63(4):1909-1917, December 2012.

In an embodiment, the original images and the corresponding Mooney images were obtained automatically using a custom made program according to the following steps.

First, concrete words were selected from a linguistic database. Using these words as search words, images were automatically downloaded from an online image database.

Second, the images were converted to grayscale and were smoothed using a 2D smooth operation with a Gaussian kernel (σ=2 pixels and full width at half maximum (FWHM)=5 pixels). Third, images were resized to have a size of 350×350 pixels (subsampled with a scale factor=new size/old size). Lastly, the smoothed and resized images were thresholded using a histogram based thresholding algorithm to generate the Mooney images (see for example in N Otsu, “A threshold selection method from gray-level histograms” IEEE Transactions on Systems, Man and Cybernetics, 9(1):62-66, 1979). Otsu's thresholding method assumes that each image has two classes of pixel properties:

a foreground and a background. For each possible threshold the algorithm iteratively computes the separability of the two classes and converges when the maximum separability is reached.

Subsequently, a selection of suitable Mooney images took place, for example 120 images.

Then the obtained original images and corresponding Mooney images are stored in the image database 6.

FIG. 4 is a view of an original image stored in the database 6 and FIG. 3 is a view of the Mooney image obtained from original image of FIG. 3. The associated label in the list of predefined labels is for example “cat”.

FIG. 6 is a view of an original image stored in the database 6 and FIG. 5 is a view of the Mooney image obtained from original image of FIG. 6. The associated label in the list of predefined labels is for example “cow”.

As set here above, selecting and remembering secure passwords puts a high cognitive burden on the user.

Authentication schemes based on implicit memory relieve the user of the burden of actively remembering a secret (such as a complicated password).

According to the invention, implicit memory can be used to link a piece of information, such as a name or label, with another one, such as an object, without user's direct conscious involvement. This link constitutes the secret used for authentication.

In a registration phase of such an authentication scheme a user gets “primed” on specific information that serves as the authentication secret, so the user does not need to actively remember the secret.

In an authentication phase, the user has to carry out a task which he can perform correctly if and only if he was previously primed on the specific information.

In an embodiment, the authentication system 5 is adapted for implementing the steps described hereabove in reference to FIG. 2.

When a new user is enrolled, in a preliminary phase 100 of registration, called also priming phase, the new user sends his enrollment request from his client terminal 2 to the authentication server 5 through the network 3.

The authentication system 5 then first assigns two disjoint subsets I_{P}, I_{N} of Mooney images stored in the database 6 (in the considered embodiment, the subset I_{P} includes a number k_{P} of images and the subset I_{N} include a number k_{N} of images) to the user identified by a user identifier.

The authentication system 5 then “primes”, i.e. trains, the user based upon subset I_{P}: each Mooney image in I_{P}, then the corresponding original image and a label that describes the object in the image is shown to the user. For example, they are sent by the authentication system 5 and presented to the user on the screen of his client terminal 1.

This training creates for the user, implicitly, an association between the original image, the correct label of the image, and the corresponding Mooney image. For example the label presented for images in FIGS. 3, 4 is “cat”, and the label for images in FIGS. 5, 6 is “cow”.

Later, each time the user requires access to resource 4 through his client terminal 2, a phase 101 of authentication is performed by the authentication system 5.

In a step 101_1, the two subsets I_{P}, I_{N} (or subsets of I_{P}, I_{N}) assigned to this user in the preliminary priming phase, are retrieved from the database 6, for example based upon the user identifier provided by the user in his request for access to resource 4.

I_{P} corresponds to the primed images; I_{N} corresponds to the non-primed images. The correspondence between the user and the images of the assigned subsets I_{P}, I_{N} is then stored in the database.

The primed and non-primed Mooney images of the two retrieved subsets I_{P}, I_{N} (I_{P} ∪ I_{N}) are then presented to the user in a pseudo-randomized order. For each Mooney image presentation, the user is requested to type in via his client terminal 2, the label of the object that the image contains, or skip the image if he is not able to recognize any object.

An alternative solution is to display each Mooney image with a list of labels. The user is then requested to select the label corresponding to the object he recognizes.

The typed label and an identifier of the Mooney image for which the label was typed (or selected) are transmitted via the network 3 from the client terminal 2 to the authentication system 5.

Two metrics are then computed for each presented image by the authentication system 5:
(i) the metric of correctness of the label is computed by comparing the typed label for each presented Mooney image to the label(s) associated with this presented image in the list of labels stored in the database 6, and by computing a distance value between the typed label and the list defined label using a distance metric that measures how similar the label provided by the user matched the defined labels. If the distance value is higher than a given distance threshold or if no label has been typed by the user, the metric of correctness of the label returns a value “incorrect”;
(ii) the recognition time, representing the time for the user to recognize the hidden object (for example estimated by the time between displaying the Mooney image on the screen of the user client terminal 2 and the first key-stroke) is recorded. In some cases, Mooney images could be labeled correctly even though they were not primed previously. This can happen when users look at the displayed Mooney image long enough and start to find associated patterns in the image that suggests a hint to the hidden object. Therefore, if the recognition time is longer than a given duration, for example approximately 20 seconds, the typed label is counted as “incorrect”.

A typed label or the absence of the typed label is considered as “incorrect” if at least one of these metrics (i), (ii) returns “incorrect”.

Authentication is based on the hypothesis that the user labels the primed images correctly more often (and faster) than those Mooney images he was not primed on. However, this effect is not perfect, so sometimes primed images will be labeled incorrectly and vice-versa.

To tolerate some of these errors, a score is then computed from the set of correct and incorrect labels provided by the user during the presentation of the Mooney images in I_{P} and I_{N}.

In the step 101_2, the authentication system 5 compares the score to a specific scoring threshold, and determines as a function of the comparison that:
the authentication of the user succeeds (for example if the score is greater than the scoring threshold) and then authorizes the access by the user to the resource 4; or else
the authentication of the user fails (for example if the score is less than the scoring threshold) ; and denies the access by the user to the resource 4.

There are several possibilities for an authentication system 5 to perform this scoring, as described in the following.

Considering that each Mooney image in the subsets I_{P}, I_{N} is indexed with a respective index i (i=1 to k_{P}+k_{N} in the specific detailed embodiment), there are four possible events to be considered:
the image I was/was not primed for the user (i.e., it is in I_{P} or in I_{N}), and
the user can provide a correct or an incorrect label for the image.

The probability (for a random user) that a user correctly labels a primed image is denoted with pᵢ, and the probability that a user correctly labels a non-primed image is denoted with nᵢ.

pᵢ is expected to be larger than nᵢ, and the difference is denoted with dᵢ:=pᵢ−nᵢ. Positive dᵢ's indicate that priming is working for this image, and reasonable images should have dᵢ>0.5.

In a scoring method, the four basic events that can occur for a single image are considered:
a primed image (with index i) is labeled correctly: occurs with probability pᵢ, and gets score s_{p,c}=A;
a primed image (with index i) is labeled incorrectly: occurs with prob. 1−pᵢ, gets score s_{p,f}=B;
a non-primed image (with index i) is labeled correctly: occurs with prob. nᵢ, gets score s_{n,c}=C;
a non-primed image (with index i) is labeled incorrectly: occurs with prob. 1−nᵢ, gets score s_{n,f}=D.

In step 101_1 the global score for all the presented Mooney images is determined by the authentication as a function of the sum of the scores each assigned to a respective presented Mooney image.

A such first scoring method, referenced herebelow as static scoring, assigns for example, the two “good” events a constant value, of 1 i.e., s_{p,c}=1, s_{n,f}=1, and of 0 to the two bad events s_{p,f}=0, s_{n,c}=0.

Static scoring does not differentiate between different probability values, which looses information.

Indeed, consider the event E* that the user wrongly labels a primed image. Let us fix a difference dᵢ=pᵢ−nᵢ=0.5, and first consider the case where pᵢ=0.5 (and thus nᵢ=0), i.e., that the primed image is labeled correct and incorrectly with the same probability. Then the event E* does carry little information, as it is a plausible outcome for a legitimate user.

Secondly, let us consider the case where pᵢ=1 (and thus nᵢ=0.5), then every primed image will be labeled correctly by the legitimate (primed) user. Thus, if event E* happens, we can be certain that it's not the legitimate user participating in the protocol.

The present invention thus proposes alternative scorings, referenced as dynamic scorings, related to a notion of self-information denoting the information content associated with a single event, as opposed to entropy which is a property of an entire distribution. The self-information I(E*) of an event E* with probability pᵢ is defined as I(E*)=−log(pᵢ), where log (.) is the logarithms for example to base 2.

In an embodiment, for an image of index i, s_{p,c} and s_{n,f} get distinct respective values (i.e. s_{p,c}≠s_{n,f}), the value of s_{p,c} being a function of pᵢ whereas the value of s_{n,f} is a function of nᵢ.

In an embodiment, for an image of index i, s_{p,f} and s_{n,c} get distinct respective values (i.e. s_{p,f}≠s_{n,c}), the value of s_{p,f} being a function of pᵢ whereas the value of s_{n,c} is a function of nᵢ.

In an embodiment, score s_{p,c} is a function of log(pᵢ), s_{p,f} is a function of log(1−pi), s_{n,c} is a function of log(nᵢ), s_{n,f} is a function of log(1−nᵢ).

In a specific embodiment, score s_{p,c}=log(pᵢ), s_{p,f}=log(1−pi), s_{n,c}=log(nᵢ), s_{n,f}=log(1−nᵢ). Consequently, the scores are negative. The authentication is thus successful only if the sum of the image scores is less than a negative threshold.

When a authentication system 5 uses such alternative scorings, the probabilities pᵢ, nᵢ have to be calculated in a preliminary step for each of the Mooney images of the database 6.

Thus for the legitimate user, the expected value, E(Sᵢ), of the score Sᵢ for a single image with index i equals

$$E ( {S}_{i} ) = \frac{1}{2} ( {p}_{i} \cdot log ( {p}_{i} ) + ( 1 - {p}_{i} ) \cdot log ( 1 - {p}_{i} ) ) + \frac{1}{2} \cdot ( {n}_{i} \cdot log ( {n}_{i} ) + ( 1 - {n}_{i} ) \cdot log ( 1 - {n}_{i} ) ) ,$$

which equals the average of the Shannon entropies of Bernoulli-distributed random variables B1,pᵢ and B1,nᵢ with mean pᵢ and nᵢ, respectively,

$$E ( {S}_{i} ) = \frac{1}{2} ( H ( B 1 , {p}_{i} ) + H ( B 1 , ni ) ) ,$$

where H(X) denotes the Shannon entropy, which is the expected value of the self-information H(X)=E[I(X)].

An authentication scheme according to the invention provides for an improved authentication.

Moreover the embodiment using Mooney images improves security and authentication usability.

The embodiment using a dynamic scoring provides for better discriminatory properties than the static scoring (as evaluated for example by the false-accept rate indicator (FAR) of the security, that gives the likelihood that an impostor is (falsely) classified as legitimate user, i.e., “accepted”) and thus provides for a better security of the authentication scheme.

An embodiment of the invention has been described hereabove using Mooney images as degraded images. Of course, degraded images of other types are usable for performing an authentication scheme according to the invention, for example other types of degraded images such as Snodgrass images or masked sound <Percept Mot Skills. 1988 August; 67(1):3-36.Perceptual identification thresholds for 150 fragmented pictures from the Snodgrass and Vanderwart picture set.Snodgrass JG1, Corwin J.

In an embodiment, the authentication scheme according to the invention is used as fallback authentication. In general, as a first authentication step after a user requests access to a protected resource a password is required.

This first authentication step may fail:
(i) when the user forgets a password and selects a field named <<forgotten password>>, or
(ii) when the password typed by the user does not match the user's password stored in the authentication system server.

Then as a second authentication step, a fallback authentication step takes place, similar to phase 101 of a method according to the invention (this embodiment requires that the user, in a previous step wherein an authentication step based upon password succeeded, registered and achieved a registration phase similar to the priming phase 100 described hereabove).

Experimentations on the method according to the invention have been performed.

The total image set comprises of 120 images. Each user is presented with 10 images, |I_{P}|=10, and 20 non-primed images |I_{N}|=20, i.e. an asymmetric distribution between primed and non-primed images. These images are randomly selected from the total image set. Parameters pᵢ,and nᵢ are measured.

For each image from the subset I_{P}, a user is first presented with the Mooney image for 3.5 seconds, with a transition to the original grayscale image, with the original image for another 3.5 seconds, with a transition back to the Mooney image. A single word as a label that describes an object hidden in the image is displayed during the original gray-scale image presentation.

In a further priming phase, the first priming phase is repeated for the same 10 images in a different, pseudo-randomized, order. Overall, a user sees each Mooney and its corresponding gray-scale image twice.

Values of pᵢ and nᵢ have been measured as data.

Data has been divided into batches by the time between enrollment and authentication:
First batch, approximately 10 days, median of 9 days;
Second batch, about three and a half weeks, median of 25 days;
Third batch, 8.5 months, median is 264.

FIGS. 7A to 7C show scatter plots for pᵢ and nᵢ respectively for the first batch (FIG. 7A), second batch (FIG. 7B), and third batch (FIG. 7C).

Line A (“prey p=r”) corresponds to an average difference d over the individual differences di=pᵢ−nᵢ for a previous work (DENNING, T., BOWERS, K., VAN DIJK, M., AND JUELS, A. Exploring implicit memory for painless password recovery. In Proceedings of the SIGCHI Conference on Human Factors in Computing Systems (2011), ACM, pp. 2615-2618).

Line B (“our p=r”) corresponds to the average difference d over the individual differences di=pi−ni for the present invention.

Line C (“p=r”) corresponds to what is named “ideal” in said previous work.

There is a moderate decline of the priming effect over first couple of weeks: the average value of the dᵢ is 0.500 for the first batch and 0.371 for the second batch, both for strict labeling. Over longer times, the decline becomes much less pronounced. 264 days after initial priming, an average dᵢ of 0.247 is measured. In the third batch, a substantial number of images has a dᵢ greater than 0.5. The values for nᵢ do not vary over time (as no priming took place). Values for pᵢ do change.

Priming on Mooney images is effective over very long times. A user can use a primed image after several weeks without a need for new priming. This is an important advantage for usability. Because the “secret” stays in memory for a long time, a user can register at a given time, and then return to the service for authentication 6-7 months later. User will be able to recognize the Mooney images, and get authenticated.

In the invention, the priming effect of Mooney images is used to help users memorizing their authentication secrets, using implicit memory instead of explicit memory. However, the security of the invention does not only depend on the properties of Mooney images. The secret used for authentication is the set of primed images I_{P}, which corresponds to a subset of the set of images presented to a user in the authentication phase. I_{P} is a randomly selected subset. There is no bias of user choice involved, unlike to passwords and many other authentication schemes. This facilitates the security analysis. The disclosed dynamic scoring method is also unique and very effective.

The authentication score is not only based on the primed images that the user is able to identify, but also on the non-primed images that the user is not able to identify. An adversary that can decode Mooney images without going through the priming phase has no advantage to break the security of the proposed scheme: the adversary does not know on which images the victim was primed on. A user connecting to the server under a false username and obtaining the presented images does not affect the security. To better avoid intersection attacks, the same set of non-primed images I_{N} is presented at each login attempt.

Conventional authentication systems degrade images that are user familiar and user not familiar images. Degraded images are shown to the user which should recognize the familiar ones.

Unlike conventional systems, the invention does not use images that are familiar to the user.

In conventional systems users provide images. Users have to actively remember the images to answer questions about the images. Conventional systems are based on explicit memory. An attacker may be able to distinguish “familiar” and “unfamiliar” images, specifically when the familiar images are provided by the user.

Unlike conventional systems, the invention is based on implicit memory. The user is primed with random information, and remembers it effort-less.

As the invention is based on implicit memory it relieves the user of the burden of actively remembering a secret, such as a complicated password. The invention significantly improves previous authentication systems by using a more efficient imprinting mechanism, particularly using the Mooney images, and optimizing the scoring mechanism.

The present invention can be implemented in hardware, software, or a combination of hardware and software. Any processor, controller, or other apparatus adapted for carrying out the functionality described herein is suitable. A typical combination of hardware and software could include a general purpose microprocessor (or controller) with a computer program that, when loaded and executed, carries out the functionality described herein.

The present invention can also be embedded in a computer program product, which comprises all the features enabling the implementation of the method described herein, and which—when loaded in an information processing system—is able to carry out this method.

A person skilled in the art will readily appreciate that various parameters disclosed in the description may be modified and that various embodiments disclosed and/or claimed may be combined without departing from the scope of the invention.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

1. A method for authenticating a user, said method being characterized in comprising the followings steps implemented by a processor:
in a training phase, presenting a user with a plurality of images called primed images and drawn randomly from a database containing images;
in an authentication phase, presenting said user with a plurality of degraded versions of at least a subset of said primed images and with a plurality of degraded versions of non-primed images extracted from said database;
receiving from said user respective identifications of said presented degraded primed images and non-primed images;
determining a global score based upon said received identifications; and
authenticating said user based upon the determined global score.

2. A method according to claim 1, wherein degraded version of an image is the Mooney image of said image.

3. A method according to claim 1, including the steps of:
determining, based upon at least identification received for a presented image, if said presented image has been correctly or incorrectly identified by the user; and
assigning to a presented image of index i an image score equal to s(i), wherein the value of s(i) if the presented image is a correctly identified primed image is calculated as a function of pᵢ, and the value of s(i) if the presented image is an incorrectly identified non-primed image is a function of nᵢ, wherein pᵢ is the probability for the image of index i to be correctly identified when primed, and nᵢ is the probability for the image of index i to be correctly identified when non primed; and
calculating the global score as a function of the sum of the image score for the presented images.

4. A method according to claim 3, wherein the value of s(i) if the presented image is a
correctly identified primed image is calculated as a function of log(pᵢ), and the value of s(i) if the presented image is an incorrectly identified non primed image is a function of log(1−nᵢ).

5. A method according to claim 3, wherein the value of s(i) if the presented image is an incorrectly identified primed image is calculated as a function of pᵢ, and the value of s(i) if the presented image is an correctly identified non-primed image is a function of nᵢ.

6. A method according to claim 5, wherein the value of s(i) if the presented image is an incorrectly identified primed image is calculated as a function of log(1−pᵢ), and the value of s(i) if the presented image is a correctly identified non-primed image is a function of log(nᵢ).

7. A method according to claim 3, wherein the determination of the correctness of the identification received for a presented image is further a function of the evaluation of the time needed by the user for providing the identification.

8. A method according to claim 3, wherein the images of index i are presented if pᵢ−nᵢ>0.5.

9. A computer program product comprising one or more stored sequences of instructions that are accessible to a processor and which, when executed by the processor, cause the processor to perform the steps of claim 1.

10. A system for authenticating a user, including a database containing images, said system being characterized in that said system is adapted for, in a training phase, presenting a user with a plurality of images called primed images and drawn randomly from the database, and is adapted for, in an authentication phase, presenting said user with a plurality of degraded versions of at least a subset of said primed images and with a plurality of degraded versions of non-primed images extracted from said database;
the system being adapted for receiving from said user respective identifications of said presented degraded primed images and non-primed images, for determining a global score based upon said received identifications; and for authenticating said user based upon the determined global score.

11. A system according to claim 1, wherein degraded version of an image is the Mooney image of said image.

12. A system according to claim 10, adapted for determining, based upon at least identification received for a presented image, if said presented image has been correctly or incorrectly identified by the user and for assigning to a presented image of index i an image score equal to s(i), wherein the value of s(i) if the presented image is a correctly identified primed image is calculated as a function of pᵢ, and the value of s(i) if the presented image is an incorrectly identified non-primed image is a function of nᵢ, wherein pᵢ is the probability for the image of index i to be correctly identified when primed, and nᵢ is the probability for the image of index i to be correctly identified when non primed; and said system being adapted for calculating the global score as a function of the sum of the image score for the presented images.

13. A system according to claim 12, wherein the value of s(i) if the presented image is a correctly identified primed image is calculated as a function of log(pᵢ), and the value of s(i) if the presented image is an incorrectly identified non-primed image is a function of log(1−nᵢ).

14. A system according to claim 12, wherein the value of s(i) if the presented image is an incorrectly identified primed image is calculated as a function of pᵢ, and the value of s(i) if the presented image is an correctly identified non-primed image is a function of nᵢ.

15. A system according to claim 14, wherein the value of s(i) if the presented image is an incorrectly identified primed image is calculated as a function of log(1−pᵢ), and the value of s(i) if the presented image is a correctly identified non-primed image is a function of log(nᵢ).

16. A system according to claim 12, adapted for determining the correctness of the identification received for a presented image as a function of the evaluation of the time needed by the user for providing the identification.

17. A system according to claim 12, adapted for presenting images of index i if pᵢ−nᵢ>0.5.
